(19) United States
(12) Patent Application Publication
(10) Pub. No.: US 2014/0233810 A1
(43) Pub. Date: Aug. 21, 2014

(54) DERMATOGLYPHIC HAND SENSOR

(71) Applicant: LUMIDIGM, INC., Albuquerque, NM (US)

(72) Inventors: William J. Spence, Albuquerque, NM (US); Paul Butler, Tijeras, NM (US); Robert K. Rowe, Corrales, NM (US)

(73) Assignee: LUMIDIGM, INC., Albuquerque, NM (US)

(21) Appl. No.: 14/226,600

(22) Filed: Mar. 26, 2014

Related U.S. Application Data
(63) Continuation of application No. PCT/US2013/033008, filed on Mar. 19, 2013.
Application No. PCT/US2013/033008 is a continuation-in-part of application No. 13/034,660, filed on Feb. 24, 2011.
(60) Provisional application No. 61/612,775, filed on Mar. 19, 2012.
(60) Provisional application No. 60/943,207, filed on Jun. 11, 2007.

(51) Int. Cl. G06K 9/00

(52) U.S. Cl. CPC G06K 9/00013
USPC 382/115

(57) ABSTRACT

Methods and systems are disclosed for performing a biometric function. A means is provided for positioning a hand of an individual in a substantially repeatable manner. An optical direct-imaging sensor is disposed relative to the means for positioning to image a portion of the hand when the hand is positioned by the means for positioning. A computational unit in communication with the optical direct-imaging sensor has instructions to operate the optical direct-imaging sensor to generate an image of the portion of the hand, and instructions to perform the biometric function with the generated image.

### CROSS REFERENCE TO RELATED APPLICATIONS

This application is a continuation of PCT Application No. PCT/US2013/033008, entitled, “DERMATOGLYPHIC HAND SENSOR,” filed Mar. 19, 2013, which is an international application and claims the benefit of U.S. Provisional Patent Application Ser. No. 61/612,775, entitled, “DERMATOGLYPHIC HAND SENSOR,” filed on Mar. 19, 2012. This application is also a continuation-in-part of and claims priority to U.S. patent application Ser. No. 13/034,660, entitled “CONTACTLESS BIOMETRIC CAPTURE,” filed Feb. 24, 2011, which is a nonprovisional of and claims the benefit of U.S. Provisional Patent Application Ser. No. 60/943,207, entitled, “CONTACTLESS MULTISPECTRAL BIOMETRIC CAPTURE,” filed on Jun. 11, 2007. The contents of all of the above-noted applications are incorporated herein by reference as if set forth in full and priority to all of these applications is claimed to the full extent allowable under U.S. law and regulations.

### BACKGROUND OF THE INVENTION

This application relates generally to biometrics. More specifically, this application relates to methods and systems for performing biometric measurements.

“Biometrics” refers generally to the statistical analysis of characteristics of living bodies. One category of biometrics includes “biometric identification,” which commonly operates under one of two modes to provide automatic identification of people or to verify purported identities of people. Biometric sensing technologies measure the physical features or behavioral characteristics of a person and compare those features to similar prerecorded measurements to determine whether there is a match. Physical features that are commonly used for biometric identification include faces, irises, hand geometry, vein structure, and fingerprint patterns, which is the most prevalent of all biometric-identification features. Current methods for analyzing collected fingerprints include optical, capacitive, radio-frequency, thermal, ultrasonic, and several other less common techniques.

Most of the fingerprint-collection methods rely on measuring characteristics of the skin at or very near the tip of a finger rather than other locations of the hand or body. In particular, optical fingerprint readers typically rely on the presence or absence of a difference in the index of refraction between the sensor platen and the fingertip placed on it. When an air-filled valley of the fingerprint is above a particular location of the platen, total internal reflectance (“TIR”) occurs in the platen because of the air-platen index difference. Alternatively, if skin of the proper index of refraction is in optical contact with the platen, then the TIR at this location is “frustrated,” allowing light to traverse the platen-skin interface. A map of the differences in TIR across the region where the finger is touching the platen forms the basis for a conventional optical fingerprint reading. There are a number of optical arrangements used to detect this variation of the optical interface in both bright-field and dark-field optical arrangements. Commonly, a single, quasimonochromatic beam of light is used to perform this TIR-based measurement.

There also exists non-TIR optical fingerprint sensors. In most cases, these sensors rely on some arrangement of quasimonochromatic light to illuminate the front, sides, or back of a fingertip, causing the light to diffuse through the skin. The fingerprint image is formed due to the differences in light transmission across the skin-platen boundary for the ridge and valleys. The difference in optical transmission are due to changes in the Fresnel reflection characteristics due to the presence or absence of any intermediate air gap in the valleys, as known to one of familiarity in the art.

Optical fingerprint readers are particularly susceptible to image quality problems due to non-ideal conditions. If the skin is overly dry, the index match with the platen will be compromised, resulting in poor image contrast. Similarly, if the finger is very wet, the valleys may fill with water, causing an optical coupling to occur all across the fingerprint region and greatly reducing image contrast. Similar effects may occur if the pressure of the finger on the platen is too little or too great, the skin or sensor is dirty, the skin is aged and/or worn, or overly fine features are present such as may be the case for certain ethnic groups and in very young children. These effects decrease image quality and thereby decrease the overall performance of the fingerprint sensor. In some cases, commercial optical fingerprint readers incorporate a thin membrane of soft material such as silicone to help mitigate these effects and restore performance. As a soft material, the membrane is subject to damage, wear, and contamination, limiting the use of the sensor without maintenance.

Optical fingerprint readers, such as those based on TIR, as well as other modalities such as capacitance, RF, and others, typically produce images that are affected to some degree by the nonideal imaging conditions present during acquisition. An analysis of the textural characteristics of the resulting images is thus affected by the sampling conditions, which may limit or obscure the ability to observe the textural characteristics of the person's skin. The consequence of this is that texture is of limited utility in such sensing modalities.

There is accordingly a general need in the art for improved methods and systems for biometric sensing.

### SUMMARY

Embodiments of the invention provide methods and systems for performing a biometric function. A means is provided for positioning a hand of an individual in a substantially repeatable manner. An optical direct-imaging sensor is disposed relative to the means for positioning to image a portion of the hand when the hand is positioned by the means for positioning. A computational unit in communication with the optical direct-imaging sensor has instructions to operate the optical direct-imaging sensor to generate an image of the portion of the hand, and instructions to perform the biometric function with the generated image.

The optical direct-imaging sensor may comprise a multispectral sensor, an optical topographic sensor, or another type of direct-imaging sensor in different embodiments. The hand may or may not be in contact with the optical direct-imaging sensor when the hand is positioned by the means for positioning.

The biometric function may comprise identifying the individual or verifying the identity of the individual in different embodiments. In one embodiment, the biometric function may further comprise spoof detection.

In one specific embodiment, the means for positioning comprises a surface and at least one locating device to be contacted by the hand when the hand is positioned by the means for positioning. The portion of the hand may comprise a volar interdigital region of a palm of the hand.

Instructions to perform the biometric function may comprise instructions to compare the generated image with an enrollment image. The enrollment image might comprise an image showing a greater portion of the hand than the generated image, such as in embodiments where the enrollment image was formed as a combination of a plurality of images.

In addition to identification and verification as described above, the biometric function may include spoof detection. Spoof detection relates to attempts to defeat a biometric sensor through presentation of a spoof sample. Various methods for overcoming such attempts are described in U.S. Pat. No. 7,801,339, which is incorporated by reference herein.

### BRIEF DESCRIPTION OF THE DRAWINGS

A further understanding of the nature and advantages of the present invention may be realized by reference to the remaining portions of the specification and the drawings, wherein like reference labels are used through the several drawings to refer to similar components. In some instances, reference labels are followed with a latin-letter sublabel; reference to only the primary portion of the label is intended to refer collectively to all reference labels that have the same primary label but different sublabels.

FIG. 1A provides an example of a typical handprint image;

FIG. 1B provides a closeup of a handprint showing some of the dermatoglyphic detail in the interdigital region;

FIGS. 2A and 2B provide a front views of biometric sensors in different embodiments of the invention;

FIG. 2C provides an illustration of a structure for a Bayer color filter array, which may be used in embodiments of the invention;

FIG. 2D is a graph showing color response curves for a Bayer color filter array like that illustrated in FIG. 2C;

FIG. 3 is a schematic representation of a computer system that may be used to manage functionality of biometric sensors in accordance with embodiments of the invention;

FIG. 4A illustrates a mechanism for repeatably positioning a hand using a locating device;

FIG. 4B is an example of a system that includes a positioning system like that shown in FIG. 4A and includes a biometric sensor like those shown in FIGS. 1A or 1B;

FIGS. 4C and 4D illustrate a biometric sensor system that uses multiple sensors in accordance with the present invention; and

FIG. 5 is a flowchart that provides a summary of methods of the invention.

### DETAILED DESCRIPTION OF EXEMPLARY EMBODIMENTS

Embodiments of the invention provide methods and systems that allow for optical imaging and processing of dermatoglyphic features of the volar surface of the hand to perform a biometric function. In particular embodiments, the methods and systems are configured to acquire dermatoglyphic features of a portion of the hand that is typically dense with relevant features. A mechanism may be included for repeatably locating the hand such that substantially the same portion of the volar surface of the hand is presented to the sensor during each measurement session. In addition, methods may be included for compensating for residual position error.

Traditional methods for acquiring fingerprint images using optical methods based on frustrated total internal reflectance (“TIR”) or semiconductor methods based on capacitance, radio-frequency (“rf”) characteristics, and the like are generally unsuitable for acquiring dermatoglyphic images on other parts of the body. The volar surface of the hand, in particular, is an area of the body that is typically dense with relevant features but that requires precise contact between the skin and the sensor for such traditional methods to function adequately.

Rather than use such traditional methods, embodiments of the invention make use of optical direct-imaging techniques such as multispectral imaging and optical topographic imaging. Multispectral-imaging techniques are described more fully in commonly assigned U.S. Pat. No. 7,147,153, entitled “MULTISPECTRAL BIOMETRIC SENSOR,” the entire disclosure of which is incorporated herein by reference for all purposes. Optical topographic imaging techniques are described more fully in commonly assigned U.S. patent application Ser. No. 13/443,534, entitled “OPTICAL TOPOGRAPHIC IMAGING (U.S. Patent Application Publication No. US-2012/0257046 A1),” filed on Apr. 10, 2012, the entire disclosure of which is also incorporated herein by reference for all purposes. While the following disclosure provides some specific examples of optical direct-imaging systems that may be used in embodiments of the invention, it is to be understood that the disclosures incorporated by reference describe other optical direct-imaging systems that may be used in alternative embodiments and such alternative embodiments are fully within the contemplation of this invention.

Embodiments of the invention make particular use of optical direct-imaging sensors that are small relative to the size of a typical human hand. Such a size may advantageously satisfy a variety of cost constraints, packaging constraints, and other such considerations. There are notably particular challenges that arise when the biometric sensing area is small relative to the area being imaged. First, the region of the hand or other body part being imaged preferably contains sufficient biometric information to provide reliable and distinct identifying information across a population of users. Second, the same region of the hand or other body part that is used for enrollment with the system should be repeatably and reliably presented to the sensing surface for dermatoglyphic image acquisition and subsequent identification or verification of identity.

The volar interdigital regions of the human palm that lie in close proximity between the metacarpals and the proximal phalanges (the metacarpophalangeal joints) typically contain dermatoglyphic features similar to those on fingertips. These features include friction ridges with endings, bifurcations, and patterns such as triradii (deltas), loops, and the like. In addition, when a hand is placed on a substantially flat surface, the interdigital regions tend to lie closer to the surface than other portions of the generally concave palm.

In addition to identification and verification of identity, the invention can be used for spoof detection. The ability to discriminate between legitimate and spoof presentations of a skin site according to embodiments of the invention is based on differences in the combined spatial and spectral properties of living skin sites when compared with spoofs. In particular, skin is a complex organ made up of multiple layers, various mixtures of chemicals, and distinct structures such as hair follicles, sweat glands, and capillary beds. The outermost layer of skin, the epidermis, is supported by the underlying dermis and hypodermis. The epidermis itself may have five identified sublayers that include the stratum corneum, the stratum lucidum, the stratum granulosum, the stratum spinosum, and the stratum germinativum. Thus, for example, the skin below the top-most stratum corneum has some characteristics that relate to the surface topography, as well as some characteristics that change with depth into the skin. While the blood supply to skin exists in the dermal layer, the dermis has protrusions into the epidermis known as “dermal papillae,” which bring the blood supply close to the surface via capillaries. In the volar surfaces of the fingers, this capillary structure follows the structure of the friction ridges on the surface. In other locations on the body, the structure of the capillary bed may be less ordered, but is still characteristic of the particular location and person. As well, the topography of the interface between the different layers of skin is quite complex and characteristic of the skin location and the person.

While spoofs may sometimes be made with considerable complexity, the structure of skin remains much more complex in both its spectral and spatial properties. In particular, spoofs have much simpler spectral properties and their spatial texture tends to be uniform with spectra. This may be contrasted with skin sites, which provide complex spectral properties in combination with a complex interplay between spatial texture and optical spectra, with nonuniformities existing in a spatial sense in addition to a spectral sense. These differences provide a basis for discrimination that may be embraced by the concept of “chromatic texture.” This is an extension of the concept of “image texture,” which refers generally to any of a large number of metrics that describe some aspect of a spatial distribution of tonal characteristics of an image. For example, some textures, such as those commonly found in fingerprint patterns or wood grain, are flowlike and may be well described by metrics such as an orientation and coherence. “Chromatic texture” extends this concept as a statistical distribution that is additionally a function of illumination wavelength, illumination angle, polarization condition and/or other changes in optical conditions within and between a plurality of images acquired during a measurement session. Certain statistical moments such as mean, variance, skew, and kurtosis may be used in quantitative descriptions of texture. Additionally or alternatively, certain other image features may be generated from the image data such as Fourier spatial frequency amplitudes and phases, wavelet magnitudes and phases, temporal changes of spectral content across the plurality of images acquired during a measurement session, and the like. Chromatic texture may be manifested by variations in pixel intensities at different spectral frequencies across an image, which may be used in embodiments of the invention to identify spoofs in biometric applications. Chromatic texture information may be acquired in embodiments of the invention by collecting an image of a purported skin site under multispectral conditions.

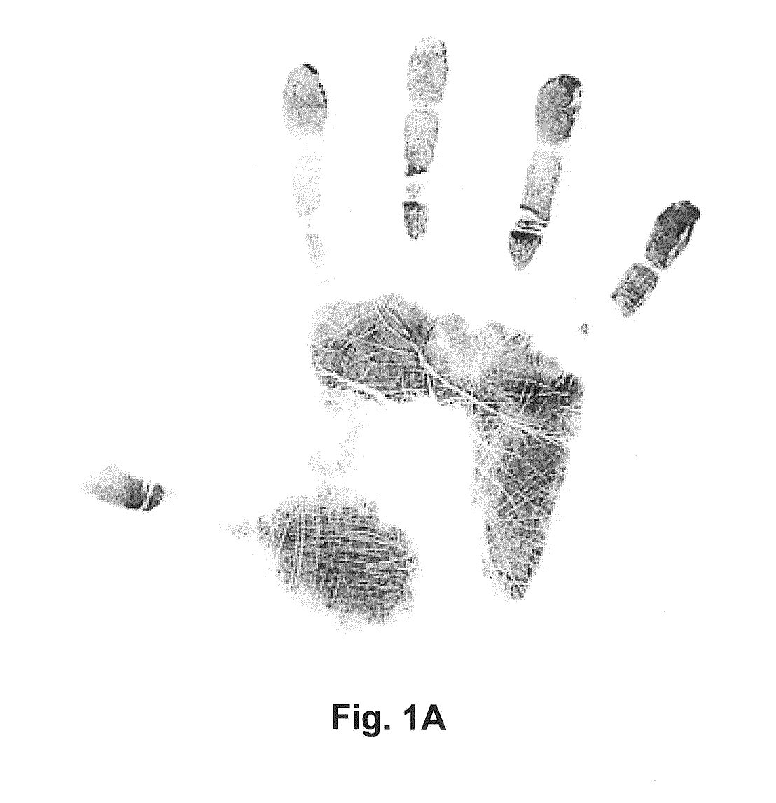

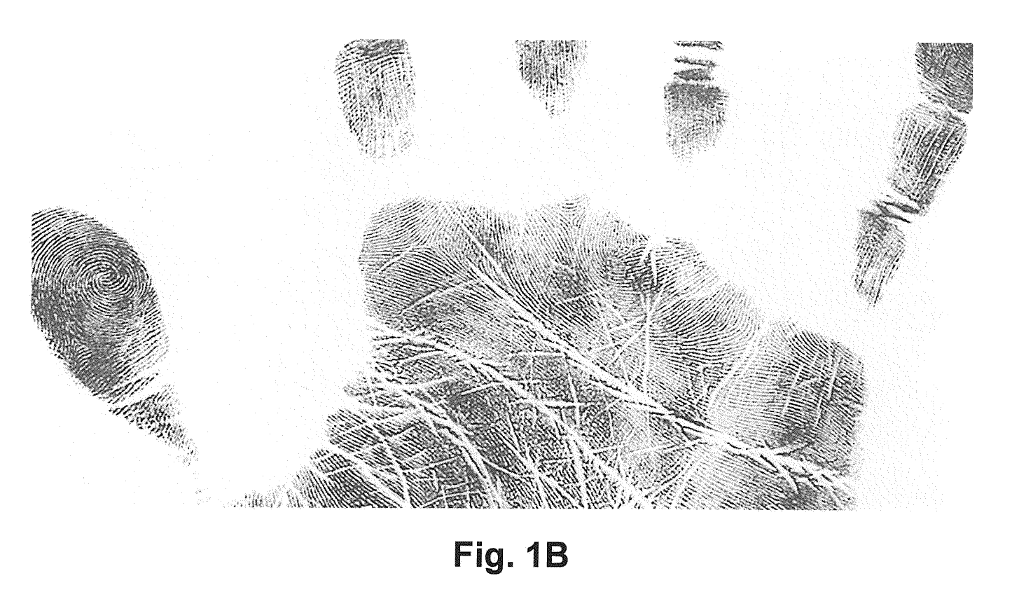

FIG. 1A illustrates a typical handprint image, generated in this instance with ink and paper. Since the hand is naturally nonplanar and somewhat concave, major portions of the hand do not touch the surface when the hand is in a relaxed configuration. In contrast, however, it is evident from FIG. 1A that the interdigital region is naturally close to the flat surface and actually touching in major portions, making this region well suited to imaging of dermatoglyphic features.

FIG. 1B shows a close-up of another handprint and demonstrates the level of dermatoglyphic detail that exists in the interdigital region, notably having a level of detail similar to what exists at the more conventional fingertip regions of the hand. Once again, this print was made using ink and paper, so many areas of the interdigital region that are not in direct contact with the surface did not contribute to the image, but similar detail extends beyond the contours of the inked image. The optical direct-imaging techniques used in embodiments of the invention, including the multispectral imaging and optical topographic imaging techniques, are also advantageously not constrained to imaging portions of the hand that are in contact with a surface, enabling access to dermatoglyphic detail that is inaccessible to conventional imaging techniques.

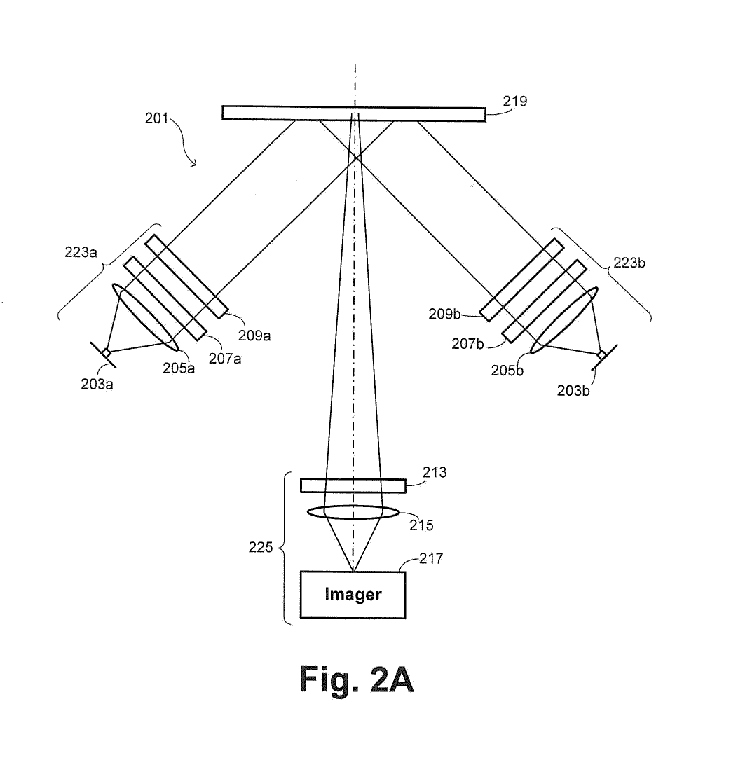

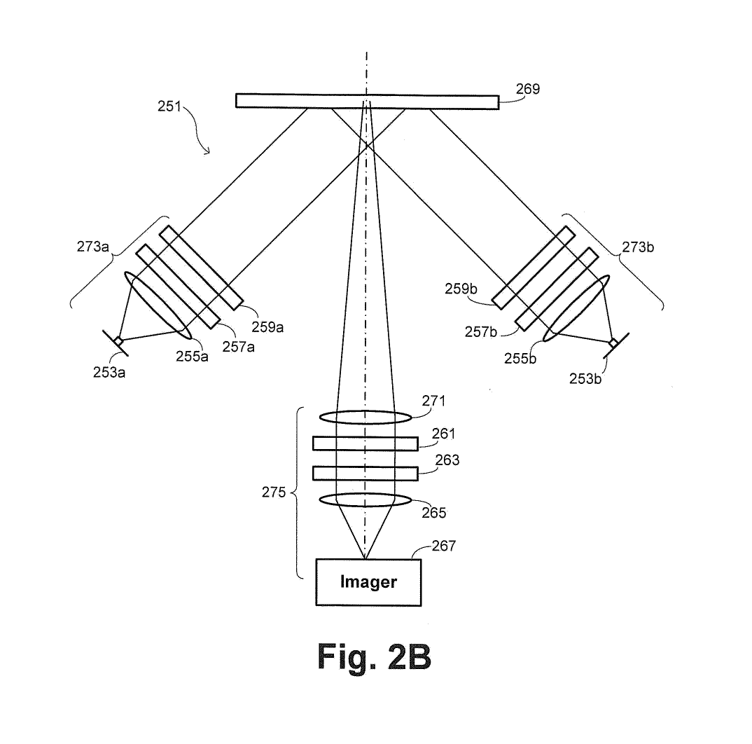

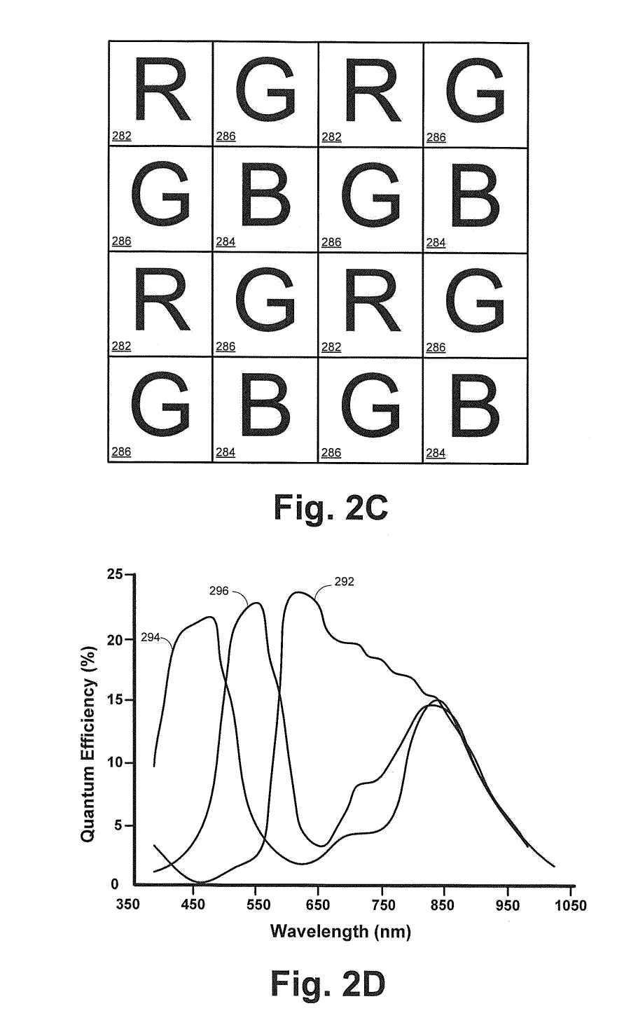

One embodiment of a sensor that makes use of multispectral techniques is illustrated with FIG. 2A. As used herein, the term “multispectral” is defined in terms of the data that may be collected during a single illumination session, with the set of all images collected under a plurality of distinct optical conditions during such a session being referred to as “multispectral data.” The different optical conditions may include differences in polarization conditions, differences in illumination angle, differences in imaging angle, and differences in illumination wavelength, differences in the time that images are acquired, among other differences in optical conditions.

FIG. 2A shows a front view of a multispectral biometric sensor 201, which comprises an illumination subsystem 223 having one or more light sources 203 and a detection subsystem 225 with an imager 217. The figure depicts an embodiment in which the illumination subsystem 223 comprises a plurality of illumination subsystems 223a and 223b, but the invention is not limited by the number of illumination or detection subsystems 223 or 225. For example, the number of illumination subsystems 223 may conveniently be selected to achieve certain levels of illumination, to meet packaging requirements, and to meet other structural constrains of the multispectral biometric sensor 201. Illumination light passes from the source 203 through illumination optics 205 that shape the illumination to a desired form, such as in the form of flood light, light lines, light points, and the like. The illumination optics 205 are shown for convenience as consisting of a lens but may more generally include any combination of one or more lenses, one or more mirrors, and/or other optical elements. The illumination optics 205 may also comprise a scanner mechanism (not shown) to scan the illumination light in a specified one-dimensional or two-dimensional pattern. The light source 203 may comprise a point source, a line source, an area source, or may comprise a series of such sources in different embodiments. In one embodiment, the illumination light is provided as polarized light, such as by disposing a linear polarizer 207 through which the light passes before striking a skin site of the person being studied.

The drawing shows a surface 219 through which light may pass in being directed to the skin site, but it is to be understood that such a surface may or may not be included in different embodiments. Techniques for reliable presentation of the skin site to the sensor are described below, and while such techniques may include a surface on which the hand is placed, this is not a necessary constraint of the invention. More generally, any reliable presentation technique may be used, including, for example, a technique that constrains a position of the hand without providing a volar-surface support for the hand.

In some instances, the light source 203 may comprise one or more quasimonochromatic sources in which the light is provided over a narrow wavelength band. Such quasimonochromatic sources may include such devices as light-emitting diodes, laser diodes, or quantum-dot lasers. Alternatively, the light source 203 may comprise a broadband source such as an incandescent bulb or glow bar. In the case of a broadband source, the illumination light may pass through a bandpass filter 209 to narrow the spectral width of the illumination light. In one embodiment, the bandpass filter 209 comprises one or more discrete optical bandpass filters. In another embodiment, the bandpass filter 209 comprises a continuously variable filter that moves rotationally or linearly (or with a combination of rotational and linear movement) to change the wavelength of illumination light. In still another embodiment, the bandpass filter 209 comprises a tunable filter element such as a liquid-crystal tunable filter, an acousto-optical tunable filter, a tunable Fabry-Perot filter, or other filter mechanism known to one knowledgeable in the art.

After the light from the light source 203 passes through the illumination optics 205, and optionally the optical filter 209 and/or polarizer 207, it passes directly to the skin site, perhaps through a surface 219. The sensor layout and components may advantageously be selected to minimize the amount of light reflected from surface 219 due to Fresnel reflection, scattering, and other such effects and subsequently seen by detection optics 215. In one embodiment, such surface reflections are reduced by relatively orienting the illumination subsystem 223 and detection subsystem 225 such that the amount of surface reflected light detected is minimized. For instance, the optical axes of the illumination subsystem 223 and the detection subsystem 225 may be placed at angles such that a mirror placed at the position of surface 219 does not direct an appreciable amount of illumination light into the detection subsystem 225. In addition, the optical axes of the illumination and detection subsystems 223 and 225 may be placed at angles with respect to surface 219 such that the angle between each of the respective optical axes and the surface 219 normal is less than the optical critical angle of the system.

Another mechanism for reducing the surface reflected light makes use of optical polarizers. Both linear and circular polarizers can be employed advantageously to make the optical measurement more sensitive to certain skin depths, as known to one familiar in the art. In the embodiment illustrated in FIG. 2A, the illumination light is polarized by linear polarizer 207. The detection subsystem 225 may then also include a linear polarizer 213 that is arranged with its optical axis substantially orthogonal to the illumination polarizer 207. In this way, light from the sample must undergo multiple scattering events to significantly change its state of polarization. Such events occur when the light penetrates the surface of the skin and is scattered back to the detection subsystem 225 after many scatter events. In some embodiments it is desirable to detect light that scatters from the surface of the skin in addition or instead of subsurface reflections. In such cases, either polarizer 207 or polarizer 213 or both may be omitted from the system. In one embodiment, a polarizer 213 may be used in the detection subsystem 225 and multiple illumination subsystems 223 may variously include or exclude polarizers 207, resulting in images taken under distinctly different polarization conditions, as well as perhaps different illumination geometries, wavelengths, and other optical differences of the sort.

The detection subsystem 225 may incorporate detection optics that comprise lenses, mirrors, and/or other optical elements that form an image of the skin site onto the imager 217. The detection optics 215 may also comprise a scanning mechanism (not shown) to relay portions of the skin-site region onto the imager 217 in sequence. In all cases, the detection subsystem 225 is configured to be sensitive to light that has illuminated the skin and either been reflected from the surface of the skin or undergone optical scatter within the skin and/or underlying tissue before exiting the skin.

The illumination subsystem 223 and detection subsystem 225 may be configured to operate in a variety of optical regimes and at a variety of wavelengths. One embodiment uses light sources 203 that emit light substantially in the region of 400-1000 nm; in this case, the imager 217 may be based on silicon detector elements or other detector material known to those of skill in the art as sensitive to light at such wavelengths. In another embodiment, the light sources 203 may emit radiation at wavelengths that include the near-infrared regime of 1.0-2.5 μm, in which case the imager 217 may comprise elements made from InGaAs, InSb, PbS, MCT, and other materials known to those of skill in the art as sensitive to light at such wavelengths. In still other embodiments, the system may use white light, with relevant considerations to such embodiments discussed below.

Another embodiment of the invention is shown schematically with the front view of FIG. 2B. In this embodiment, the multispectral biometric sensor 251 comprises a broadband illumination subsystem 273 and a detection subsystem 275. As for the embodiment described in connection with FIG. 2A, there may be multiple illumination subsystems 273 in some embodiments, with FIG. 2B showing a specific embodiment having two illumination subsystems 273. A light source 253 comprised by the illumination subsystem 273 is a broadband illumination source such as an incandescent bulb or a glowbar, or may be any other broadband illumination source known to those of skill in the art. Light from the light source 253 passes through illumination optics 255 and, optionally, a linear polarizer 257, and may optionally pass through a bandpass filter 259 used to limit the wavelengths of light over a certain region. The light may or may not pass through a surface 269 depending on the mechanism used for reliable presentation of the skin site into which it is directed. A portion of the light is reflected from the skin (surface and diffuse) into the detection subsystem 275, which comprises imaging optics 265 and 271, an optional crossed linear polarizer 261, and a dispersive optical element 263. The dispersive element 263 may comprise a one- or two-dimensional grating, which may be transmissive or reflective, a prism, or any other optical component known in the art to cause a deviation of the path of light as a function of the light's wavelength. In the illustrated embodiment, the first imaging optics 271 acts to collimate light reflected from the skin for transmission through the crossed linear polarizer 261 and dispersive element 263. Spectral components of the light are angularly separated by the dispersive element 263 and are separately focused by the second imaging optics 265 onto an imager 267. As discussed in connection with FIG. 2A, the polarizers 257 and 261 respectively comprised by the illumination and detection subsystems 273 and 275 act to reduce the detection of directly reflected light at the detector 317.

The multispectra I image generated from light received at the detector is thus a “coded” image in the manner of a computer tomographic imaging spectrometer (“CTIS”). Both wavelength and spatial information are simultaneously present in the resulting image. The individual spectral patterns may be obtained by mathematical inversion or “reconstruction” of the coded image.

In embodiments where white light is used, the imager 217 or 267 may comprise a Bayer color filter array in which filter elements corresponding to a set of primary colors are arranged in a Bayer pattern. An example of such a pattern is shown in FIG. 2C for an arrangement that uses red 282, green 286, and blue 284 color filter elements. In some instances, the detector subsystem 225 or 275 may additionally comprise an infrared filter (not shown) disposed to reduce the amount of infrared light detected. As seen from the color response curve for a typical Bayer filter array shown in FIG. 2D, there is generally some overlap in the spectral ranges of the red 292, green 294, and blue 296 transmission characteristics of the filter elements. As evident particularly in the curves for the green 294 and blue 296 transmission characteristics, the filter array may allow the transmission of infrared light. This is avoided with the inclusion of an infrared filter as part of the detector subsystem. In other embodiments, the infrared filter may be omitted and one or more light sources that emit infrared light may be incorporated. In this way, all color filter elements 282, 284, and 286 may allow the light to substantially pass through, resulting in an infrared image across the entire imager.

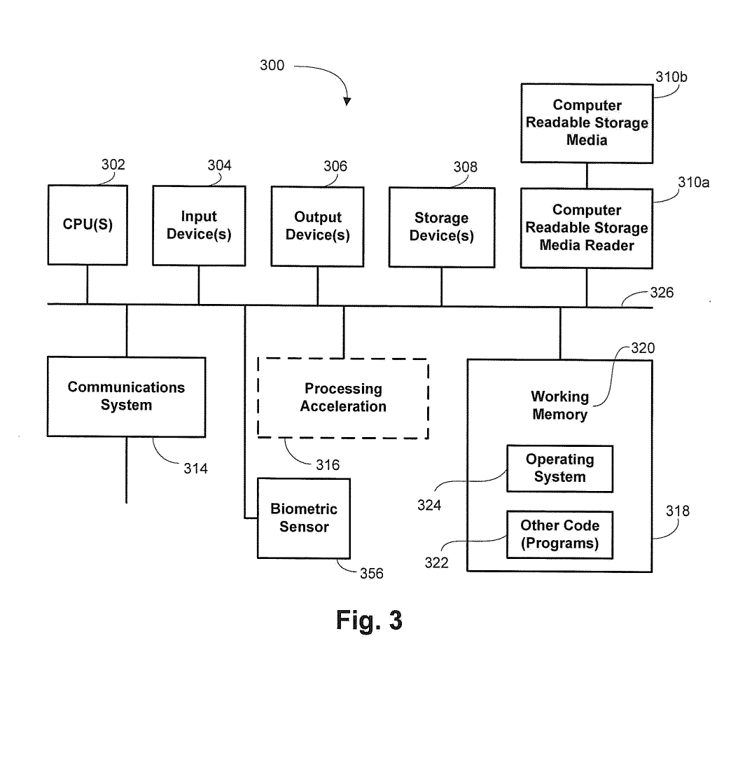

Management of the functionality of the biometric sensor may be performed with a computer system such as illustrated in FIG. 3. The arrangement shown in FIG. 3 includes a number of components that may be appropriate for a larger system; smaller systems that are integrated with biometric sensor 356 itself may use fewer of the components. FIG. 3 broadly illustrates how individual system elements may be implemented in a separated or more integrated manner. The computational device 300 is shown comprised of hardware elements that are electrically coupled via bus 326. The hardware elements include a processor 302, an input device 304, an output device 306, a storage device 308, a computer-readable storage media reader 310a, a communications system 314, a processing acceleration unit 316 such as a DSP or special-purpose processor, and a memory 318. The computer-readable storage media reader 310a is further connected to a computer-readable storage medium 310b, the combination comprehensively representing remote, local, fixed, and/or removable storage devices plus storage media for temporarily and/or more permanently containing computer-readable information. The communications system 314 may comprise a wired, wireless, modem, and/or other type of interfacing connection and permits data to be exchanged with external devices.

The computational device 300 also comprises software elements, shown as being currently located within working memory 320, including an operating system 324 and other code 322, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

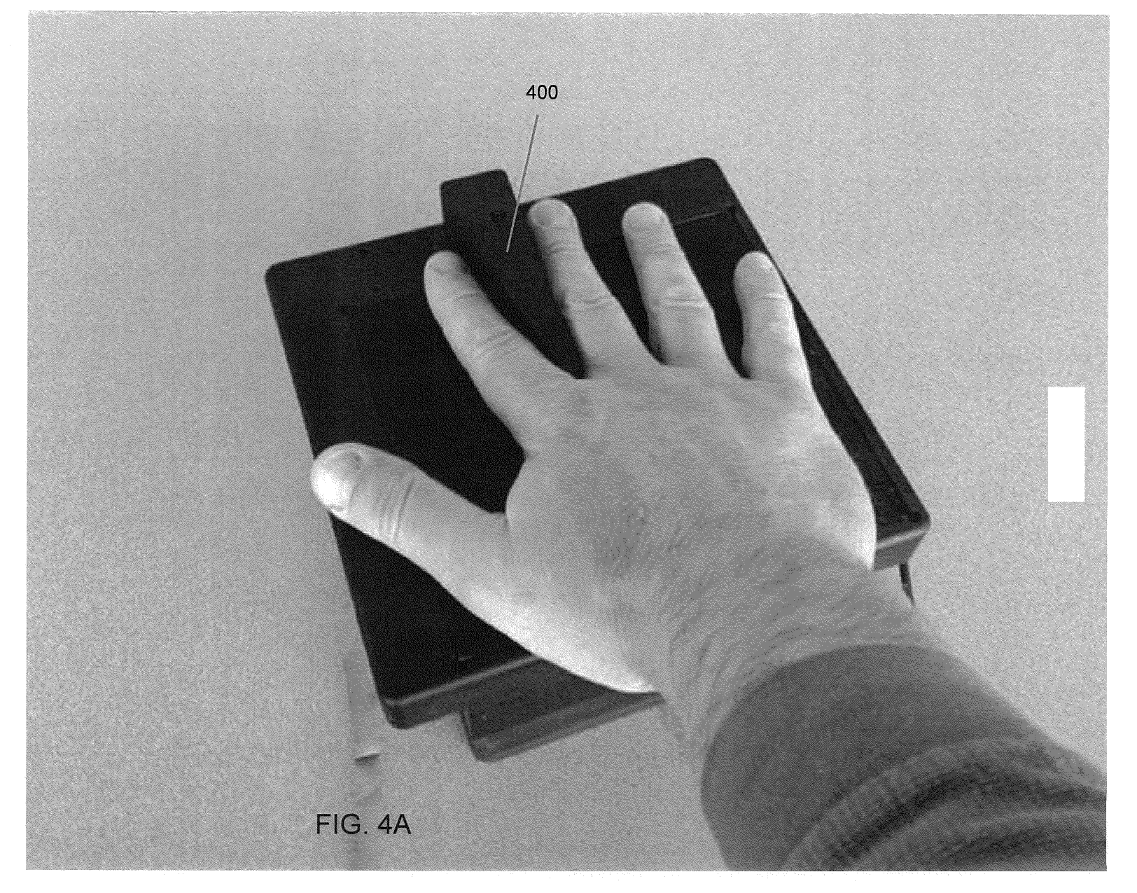

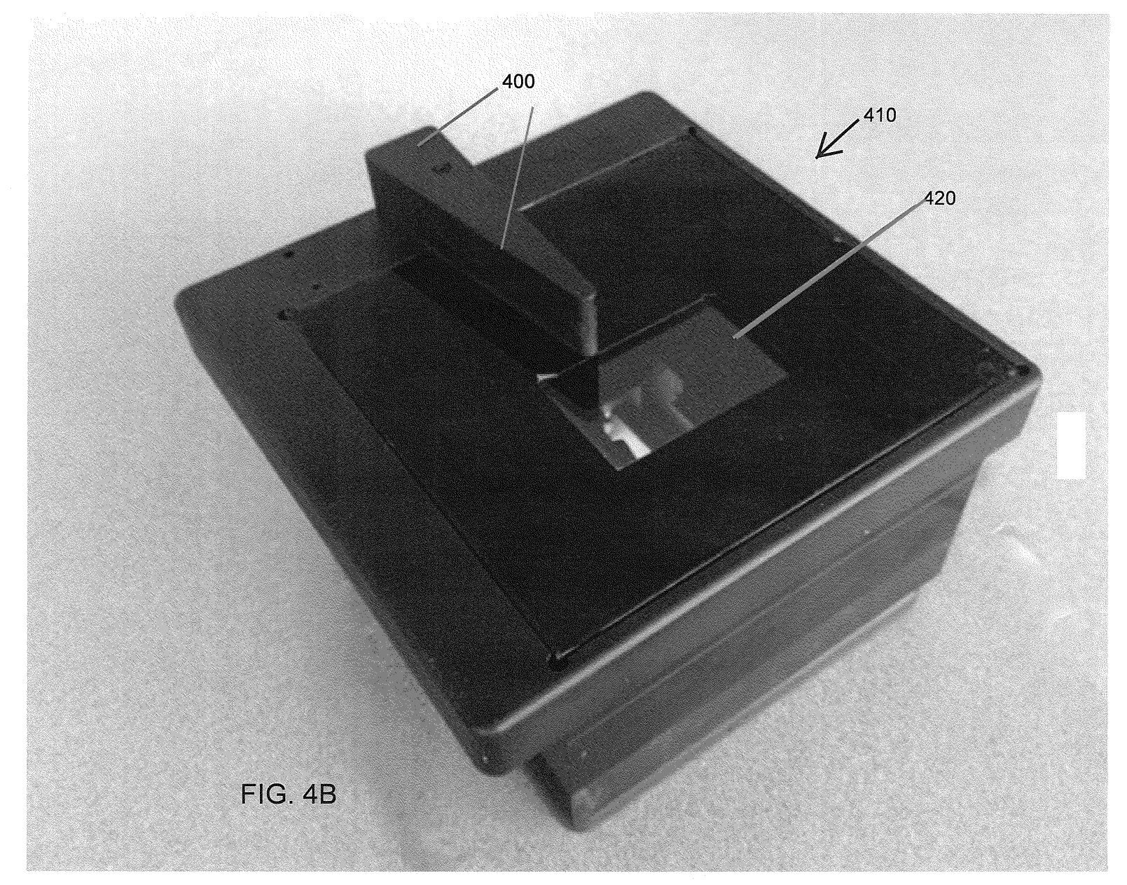

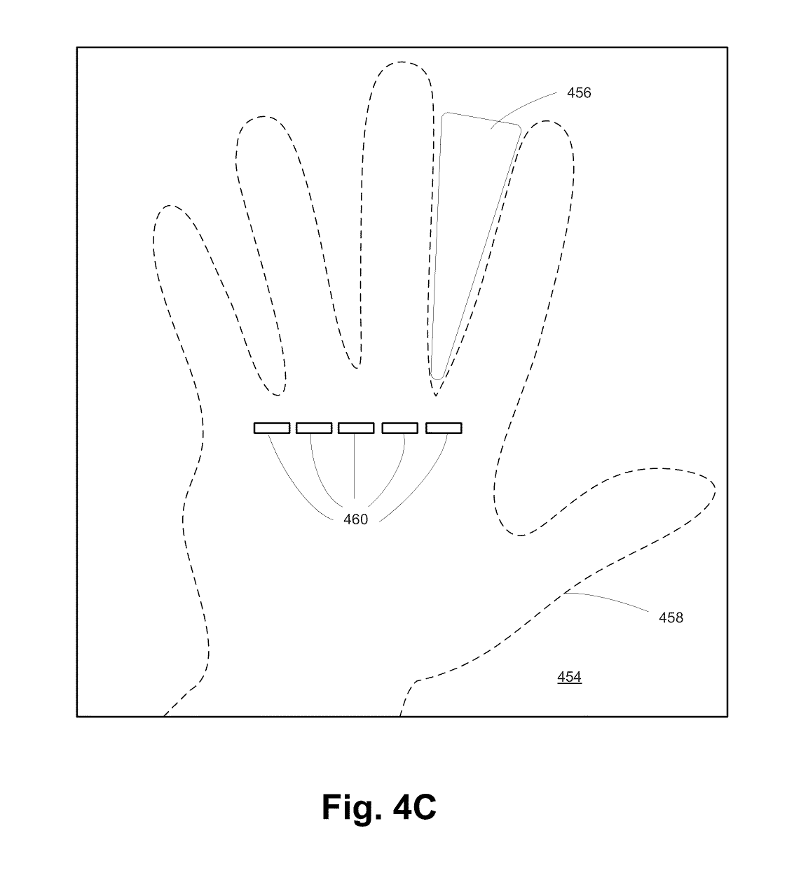

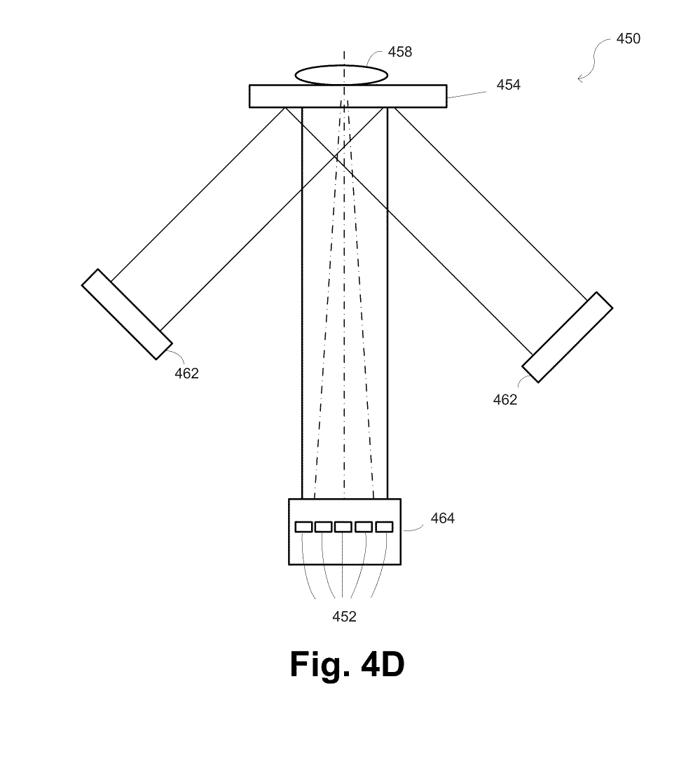

In order to be useful for dermatoglyphic pattern matching, the hand is preferably positioned relative to the biometric sensor such that substantially the same portion of skin as used for matching is within the sensor's field of view. One aspect of the invention illustrated in FIGS. 4A and 4B provides for repeatable positioning by locating the index and middle fingers using a mechanical stop 400. In this specific instance mechanical stop 400 is located just at the edge of the sensing area 420 of sensor 410. In other embodiments mechanical stop 400 may protrude into the sensing area 420 such that the proximity of the fingers to the mechanical stop 400 may be determined from one or more images acquired with detecting subsystem 410. In this way, proper positioning of the fingers may be determined automatically and used to initiate an acquisition sequence and/or provide guidance for proper hand placement. The specific arrangement shown in the drawing uses a single locating device but many other equivalent and/or alternative configurations are possible. Other examples include the use of pegs, edges, indentations, protrusions, sculpted features, as well as visual markings, machine vision, and/or audio/visual feedback separately or in combination to achieve such an effect.

FIG. 4B is a photograph of a system that uses a positioning system like that shown in FIG. 4A. It is emphasized that the illustrated size and placement of the biometric sensor 410 are exemplary, and that other sizes and/or or placements are also within the intended scope of the invention. Also within the scope of the invention is the incorporation of a plurality of small biometric sensors at different positions beneath the hand to acquire images from a plurality of different portions of the interdigital region.

FIGS. 4C and 4D show a biometric sensor system 450 incorporating a number of small biometric sensors 452 in accordance with an alternative implementation of the present invention. In particular, FIG. 4C is a top view showing a platen 454 and a mechanical stop 456 for positioning a subject's hand 458 with respect to the platen 454. In the illustrated embodiment, the system 450 includes a number of sensing areas 460 positioned for acquiring biometric information for the volar interdigital regions of the human palm. Although five sensing areas 460 arranged in a linear array are shown for purposes of illustration, a different number of sensing areas in a different pattern may be utilized. For example, the sensing areas, and corresponding sensors, may be arranged in an arcuate form, in rows and columns, or in another two or three dimensional array.

FIG. 4D is a schematic diagram of the biometric sensor system 450. The system 450 may be, for example, a multispectral biometric sensor system as described above in connection with FIGS. 2A and 2B. As described above, there may be multiple illumination subsystems in some embodiments, with FIG. 4D showing a specific embodiment having two illumination subsystems 462. In other embodiments, there may be one or more illumination subsystems 462 per sensor 452. Each of these illumination subsystems may include one or more light sources (e.g., broadband or quasimonochromatic), optics, filters, polarizers and other components as discussed above, and provides illumination that may be focused, collimated, or diverging depending on the particular system implementation. In this illustrated system 450, the illumination is received by a detection subsystem 464 that includes the sensors 452. As discussed above in connection with the embodiments of FIGS. 2A and 2B, the detection subsystem 464 may further include imaging optics, a polarizer, dispersive optical elements and other components for conditioning illumination for the sensors 452.

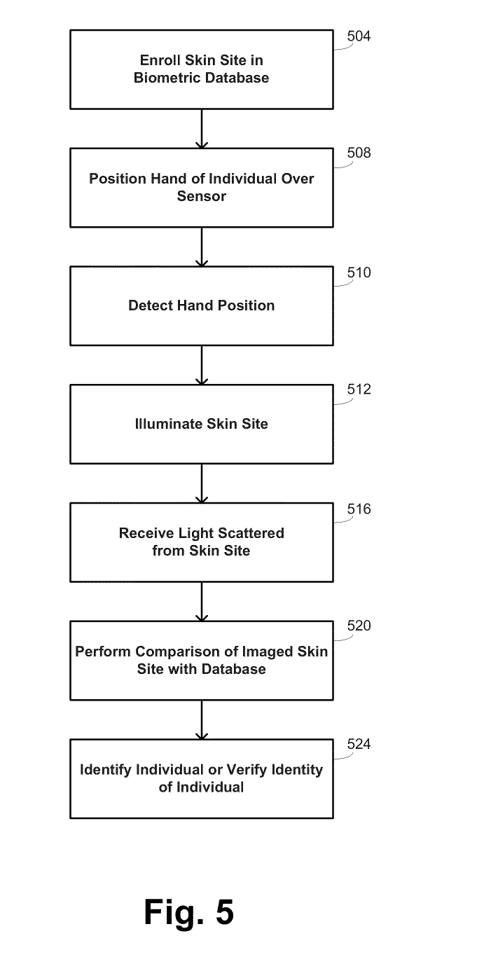

FIG. 5 provides a summary of methods of the invention. At block 504, the skin site of an individual is enrolled in a biometric database. Residual positioning errors in subsequent attempts to perform biometric functions using enrolled skin sites can be addressed in some embodiments as follows. Such residual positioning errors will depend on the exact design of the positioning system, particularly the field of view of the biometric sensor, as well as on other aspects of the environment in which the system operates. In one embodiment, compensation is made for such error by forming the enrollment data from multiple images taken over multiple placements of the hand in the positioning apparatus. This may be done during a single short period of time, i.e. the enrollment session, or may take place over a more extended time interval. Preferably, an approximation of the full range of positions under which enrollment images are acquired encompass the range of positions of the hand during subsequent usage. In some embodiments the enrollment image may be acquired using the methods of the present invention. Alternatively in some embodiments the enrollment data may be acquired using other means such as ink and paper, other optical methods such as those based on total internal reflectance, and other means known in the art.

At block 508, the hand of an individual is positioned over the sensor and within the positioning system as part of making a measurement to perform a biometric function. The skin site is illuminated at block 512 and light scattered from the skin site is received at block 516. The received light and/or other feedback may be analyzed to detect hand position at block 510. For example, where the mechanical stop protrudes into the sensing area or areas, the proximity of the fingers to the stop may be determined from the image or images. A comparison of the imaged skin site is made with the database at block 520 so that the biometric function of identifying the individual or verifying the individual's identity, and/or spoof detection may be performed at block 524.

There are a number of different variations in how the comparison at block 520 may be performed. For instance, enrollments that comprise multiple images may be used for matching in a variety of ways. In one embodiment, when a user places a hand on the sensor for identity verification, the current dermatoglyphic image may be matched with each of the enrollment images separately. The most similar match of those may then be used for identity determination. Alternatively, the N best matches, the mean match, the median match, or other such operations may be used for identity determination.

In another variant, multiple separate enrollment images may be combined together to form a single enrollment image that includes more of the skin area than any of the individual images. Such an image generation may be performed, for instance, by using photo stitching techniques similar to those known in the art for creating panorama photos from a collection of smaller overlapping photos.

As an alternative or in addition to collecting multiple enrollment images during a single enrollment session, enrollment information may be updated continuously during use or during certain prescribed times. Such updating can be accomplished in instances where a match has been determined but where the present image spans a portion of skin that lies beyond the range currently contained in the enrollment dataset. In such cases, the current image may be included in the dataset as either another individual image or as an additional image that is photo-stitched into the composite enrollment image.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed:

1. A system for performing a biometric function, the system comprising:
means for positioning a hand of an individual in a substantially repeatable manner;
an optical direct-imaging sensor disposed relative to the means for positioning to image a portion of the hand when the hand is positioned by the means for positioning; and
a computational unit in communication with the optical direct-imaging sensor, the computational unit comprising:
instructions to operate the optical direct-imaging sensor to generate an image the portion of the hand; and
instructions to perform the biometric function with the generated image.

2. The system recited in claim 1 wherein the optical direct-imaging sensor comprises a multispectral sensor.

3. The system recited in claim 1 wherein the optical direct-imaging sensor comprises an optical topographic sensor.

4. The system recited in claim 1 wherein the hand is in contact with the optical direct-imaging sensor when the hand is positioned by the means for positioning.

5. The system recited in claim 1 wherein the hand is not in contact with the optical direct-imaging sensor when the hand is positioned by the means for positioning.

6. The system recited in claim 1 wherein the biometric function comprises identifying the individual.

7. The system recited in claim 1 wherein the biometric function comprises verifying an identity of the individual.

8. The system recited in claim 1, wherein the biometric function comprises detecting an attempt to spoof biometric information of the individual.

9. The system recited in claim 1 wherein the means for positioning comprises a surface and a mechanical stop to be contacted by the hand when the hand is positioned by the means for positioning.

10. The system recited in claim 1 wherein the portion of the hand comprises a volar interdigital region of a palm of the hand.

11. The system recited in claim 1 wherein the instructions to perform the biometric function comprise instructions to compare the generated image with an enrollment image.

12. The system recited in claim 11 wherein the enrollment image comprises an image showing a greater portion of the hand than the generated image.

13. The system recited in claim 12 wherein the enrollment image was formed as a combination of a plurality of images.

14. The system recited in claim 1, wherein said optical direct-imaging sensor includes a plurality of sensors for imaging portions of the hand.

15. A method for performing a biometric function, the method comprising:
positioning a hand of an individual with a means for positioning the hand in a substantially repeatable manner;
generating an image of a portion of the hand with an optical direct-imaging sensor disposed relative to the means for positioning the hand to image the portion of the hand; and
performing the biometric function with the generated image.

16. The method recited in claim 15 wherein the optical direct-imaging sensor comprises a multispectral sensor.

17. The method recited in claim 15 wherein the optical direct-imaging sensor comprises an optical topographic sensor.

18. The method recited in claim 15 wherein positioning the hand comprises positioning the hand in contact with the optical direct-imaging sensor.

19. The method recited in claim 15 wherein positioning the hand comprises positioning the hand such that the hand is not in contact with the optical direct-imaging sensor.

20. The method recited in claim 15 wherein performing the biometric function with the generated image comprises identifying the individual.

21. The method recited in claim 15 wherein performing the biometric function with the generated image comprises verifying an identity of the individual.

22. The method recited in claim 15, wherein performing the biometric function with the generated image comprises detecting an attempt to spoof biometric information of the individual.

23. The method recited in claim 15 wherein the means for positioning comprises a surface and a mechanical stop to be contacted by the hand when the hand is positioned by the means for positioning.

24. The method recited in claim 15 wherein the portion of the hand comprises a volar interdigital region of a palm of the hand.

25. The method recited in claim 15 wherein performing the biometric function with the generated image comprises comparing the generated image with an enrollment image.

26. The method recited in claim 25 wherein the enrollment image comprises an image showing a greater portion of the hand than the generated image.

27. The method recited in claim 26 wherein the enrollment image was formed as a combination of a plurality of images.

28. The method recited in claim 15 wherein said step of generating an image comprises using a plurality of sensors for imaging portions of the hand.
